(19) United States
(12) Patent Application Publication
(10) Pub. No.: US 2004/0122939 A1
(43) Pub. Date: Jun. 24, 2004

(54) Method of obtaining economic data based on web site visitor data

(76) Inventor: Russell Perkins, Wynnewood, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/325,532

(22) Filed: Dec. 19, 2002

(51) Int. Cl. G06F 15/173

(52) U.S. Cl. 709/224

(57) ABSTRACT

A system and method for obtaining information about web site visitors is configured to access and compile economic data about such visitors. Multiple reverse-resolving methods are employed to identify visitor organization based on rDNS data, WHOIS data, and IP address delegations. Visitor organization data is then used to obtain economic data such as industry codes, locations, and revenue ranges corresponding to such organizations.

### FIELD OF THE INVENTION

The present invention relates to analysis of web server visitor data. In particular, the present invention relates to obtaining and organizing data relating to an economic profile of visitors to a web site.

### BACKGROUND

Knowing whether one is reaching one's intended audience is a primary concern of advertisers in any medium. A related concern is determining what audience is being reached, and identifying an advertiser's potential customers. The world wide web has provided a level of interactivity between an advertiser and potential customers which has previously been unavailable in other media. While an advertiser may attempt to collect data on visitors to a web site by having visitors fill out interactive forms, the Hypertext Transfer Protocol (HTTP) allows passive collection of certain rudimentary information about visitors to a web site. However, such information is not directly commercially useful.

When a web page is visited, an exchange of routing information takes place between the visitor's browser program and the web server hosting the visited web site. The browser, having resolved the Uniform Resource Locator (URL) of the web site, issues an HTTP-request message to the web server. The HTTP-request message identifies the particular file on the web server which the visitor desires to view. In order to view the web site at http://www.example.com, the user's browser first queries the Domain Name System (DNS) to obtain the Internet protocol (IP) address of the web server for example.com. By convention, when no file is specified, the web server at example.com will then transmit a file identified as “index.html” to the user's browser. In order to permit the web server to transmit the file to the visitor's computer, it is necessary for the web server to be provided with the IP address of the visitor's computer. This return routing information is provided in the HTTP-request message as what is called HTTP-request header data. HTTP-request header data includes the IP address to which data responsive to the request is to be sent. By convention, the HTTP-request header typically includes additional data, such as a domain name of the requesting computer if the requesting computer is configured to provide reverse-DNS (rDNS) data in its HTTP-request headers. For example the HTTP-request header may include “66.9.220.100 userhost5.somehost.net”, where 66.9.220.100 is the IP address of the visitor's computer, and where userhost5.somehost.net is the rDNS domain name provided by the visitor's computer. Web server software, such as Apache server software, maintains a log file of HTTP-request messages, in which all HTTP-requests are stored, and may further be configured to obtain and record rDNS host data, if available.

Log file analysis programs have been developed in order to provide web site operators with information about who is visiting their web site. For example U.S. Pat. No. 6,317,787 entitled “System and Method for Analyzing Web-Server Log Files” describes a log file analysis program which sorts log file data and provides statistics of various data fields extracted from the log file data. Such log file analyzers typically rely on rDNS data within HTTP-request headers in order to provide a web server operator with tables or graphs showing the number of visitors originating from various host domain names. Furthermore, rough “geographical” information can be provided on the basis of sorting the host domain names according to their top-level domains (TLDs), such as by country-code top-level domains (ccTLDs) in order to provide statistics identifying a presumed countries of origin on the basis of corresponding ccTLDs. Similar types of rough statistical analyses can be conducted on the basis of real-time data generated by a web server, instead of analyzing log files at predetermined intervals.

Existing visitor analysis programs, whether they operate on the basis of log file analysis or real-time analysis of HTTP-request data, have several shortcomings from the perspective of a web site operator desiring to obtain meaningful visitor information. A primary shortcoming is that knowing one has obtained a number of visits from “somehost.com” does not readily inform the web site operator of whether visitors from “somehost.com” are potential customers or competitors, what types of goods or services may be of interest to “somehost.com”, the business in which visitors from “somehost.com” are engaged, or the economic importance of visitors from “somehost.com”. Moreover, many hosts are not configured to provide rDNS data, hence vast numbers of HTTP-requests are logged solely by the IP address of the visitor, which by itself does not provide meaningful information to the web site operator, and are typically discarded by domain-based log file analysis programs. One of the reasons for unavailable rDNS host names is that many organizations use one or more IP addresses for outbound traffic, such as HTTP requests, and a distinct one or more IP addresses for inbound traffic.

In view of the foregoing drawbacks, it would be desirable to provide a system for analyzing web site visitor traffic in terms which are of immediate economic usefulness to a web site operator.

### SUMMARY

In accordance with the present invention, there is provided a system for obtaining and presenting economically significant data about web site visitors to a web site operator. In accordance with one aspect of the present invention, domain name WHOIS data pertaining to the host domain names of web site visitors is obtained in order to determine the actual organization name from which web site visitors originate. In accordance with another aspect of the present invention, web site visitor data consisting solely of IP address numbers is analyzed by first querying IP address WHOIS data maintained by Regional Internet Registries to identify the organization names of web site visitors. In cases where the organizational identity of visitors is not resolvable on the basis of IP address WHOIS data corresponding to the HTTP-request header obtained from the visit, the system according to the present invention identifies a corresponding IP address block, and scans addresses within the identified IP address block in order to identify a probable visitor organization on the basis of host names found at neighboring IP addresses within the block.

In accordance with another aspect of the present invention, after the organizational identity of web site visitors are identified, the organizational identity is used to further query a database of economic or business commercial data to obtain detailed demographic statistics on visitors to the web site. Such demographic statistics may include industrial sector data, such as Standard Industrial Code (SIC) or North American Industry Classification System (NAICS) group and industry statistics; and revenue statistics pertaining to the visitor's organization; along with information identifying which pages were visited by visitors from such organizations, how long their visits lasted. Hence, an advantage is provided over prior log file analysis systems which have not had the capability of compiling such data according to economically significant visitor identifications or classifications.

### BRIEF DESCRIPTION OF THE DRAWING

FIG. 1 is a block functional diagram of an economic and demographic data reporting system in accordance with the present invention; and

FIG. 2 is a logical flow diagram of a procedure performed by an address parser of the system of FIG. 1; and

FIG. 3 is a design of a report page generated by the system of FIG. 1; and

FIG. 4 is a design of a report page generated by the system of FIG. 1; and

FIG. 5 is a design of a report page generated by the system of FIG. 1

### DETAILED DESCRIPTION

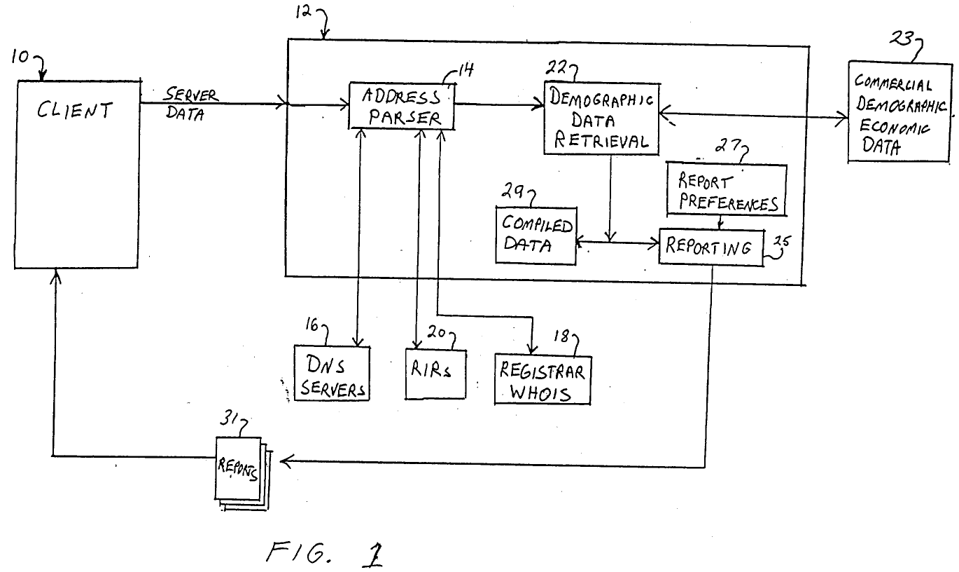

A block diagram of an embodiment of the invention is shown in FIG. 1. A web site operator, such as a client 10, provides web server data to a web visitor analysis and reporting system 12. The web server data may be provided in the form of a periodic upload of web server log files, or by a real time mechanism, such as transmitting received HTTP-request headers to the system 12. In other embodiments, the web site itself may be configured to include external HTTP references to a server associated with the system 12, so that HTTP-request data is remotely collected by the system 12 as visits to the client's web server are made.

Within the web visitor analysis and reporting system, there is provided an address parser 14. The address parser obtains the IP address or rDNS host address recorded within the HTTP-request header of each recorded visit, and associates each address with an organization to whom the address is assigned. The address parser 14 is configured to interactively query Internet DNS servers 16, Internet domain name WHOIS servers 18, Regional Internet Registry WHOIS servers 20, as described further below in order to identify an originating organization corresponding to each HTTP-request in the web server data, and to compile visitor statistics for each identified organization. When the parsed web server data has been transformed into compiled organization data, the compiled organization data is passed from the address parser to a demographic data retrieval system 22 in order to obtain demographic data for each identified organization.

The demographic data retrieval system 22 is configured to interactively query an external database 23 of demographic data, such as economic data. In a preferred embodiment, the external database is a business data directory maintained by Dunn & Bradstreet. In other embodiments, the external database may include census data, revenue data, industrial classification data, stock exchange data, or combinations of demographic data contained within known demographic and economic databases. Data elements retrieved by the demographic data retrieval system may include such data as geographic location, postal codes, street addresses, revenue figures, and industry classification data such as Standard Industrial Codes in order to identify industry groups or specific industries of web site visitors. The demographic data retrieval system associates the compiled organization data with specific data elements selected from the external database 23 in accordance with reporting preferences stored by the system 12, and stores the associated data in a database 29.

After the desired data elements have been associated with the compiled organization data, the associated data is passed to a report generator 25. The report generator 25 produces tabular and or graphical reports 31 of web site visitors arranged with the demographic data obtained by the demographic data retrieval system, in accordance with report preferences specified by the client 10, as described further below. Such report formats may be predetermined static report formats, or may be generated dynamically based upon interactive input supplied by the client.

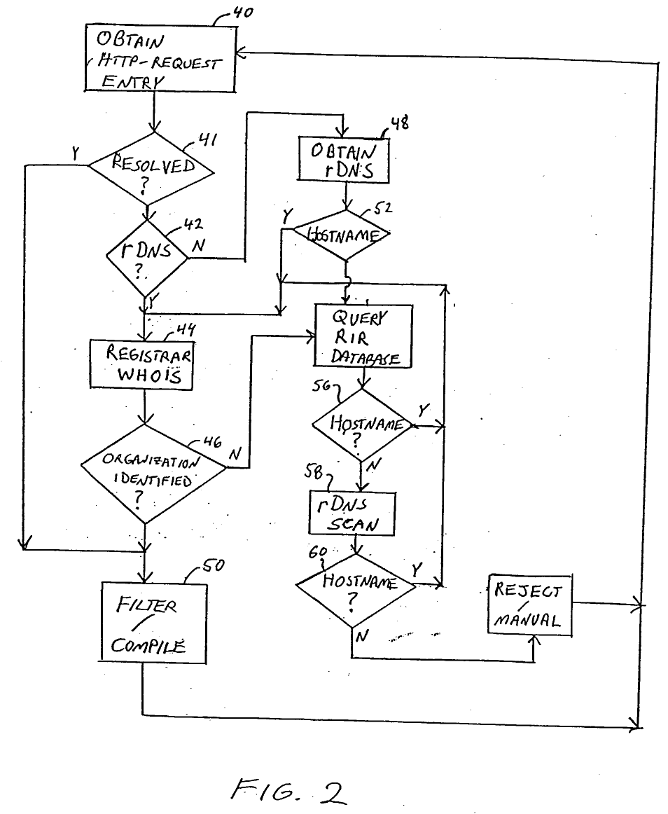

Referring now to FIG. 2, there is shown a logical flow diagram showing the steps performed by the address parser and the demographic data retrieval system. Beginning at step 40, the address parser obtains an HTTP-request entry. The HTTP-request data may be obtained from a server log file, or in real-time or non-real time according to periodic transmissions of server data from the client. Alternatively, the HTTP-request data may be obtained by inclusion of data elements within the client's web site which cause HTTP-request data to be submitted to the analysis system in cooperation with “hits” obtained by the client's web server. The address parser then proceeds to step 41.

In step 41, the address parser determines whether the entry has previously been resolved. If the entry has been resolved or deemed unresolvable, then the address parser proceeds to step 50. Otherwise, the address parser proceeds to step 42.

In step 42, the address parser determines whether an rDNS hostname is present in the HTTP-request data supplied in step 40. If a hostname is present, the address parser proceeds to step 44. If only an IP address is present to identify the visitor's host, then the address parser proceeds to step 48.

In step 44, the address parser performs a WHOIS search to identify the organization responsible for the identified hostname. Domain name WHOIS data, when available, identifies a registrant for each Internet domain name. However, whether such registrant identification is available may depend upon the top-level domain name. For example, country code top-level domain registries may or may not provide readily available whois data. Additionally, WHOIS data for generic top-level domain names is distributed among various registrars accredited by the Internet Corporation for Assigned Names and Numbers (ICANN). Techniques for conducting a cross-registrar WHOIS search are known, and may be incorporated in the method employed in step 44. For example, in generic top-level domains, a two-step process can be employed in which the generic top-level registry is queried to identify the registrar responsible for the domain name, and then the registrar WHOIS server is queried to obtain the WHOIS record identifying the domain registrant. In order to separate the registrant data from the rest of the WHOIS data, the address parser is provided with a set of rules corresponding to the various formats in which Internet domain registrars provide WHOIS data. From step 44, the address parser proceeds to step 46

It may happen that registrant data is not available for the hostname provided on entry to step 44. Hence, in step 46, if the domain name registrant organization was not identified, then the address parser proceeds to step 48. If the domain name registrant was identified in step 44, then the address parser proceeds to step 50.

At step 48, the only information resolved thus far is the IP address of the visitor. In the event the client web server was not configured to obtain and log rDNS data, then the address parser performs an rDNS query in step 48 and proceeds to step 52. In step 52, it is determined whether a hostname was found. If in step 52 a hostname was found (and if the hostname does not match a name previously deemed unresolvable in step 44), then the address parser proceeds to step 44. Otherwise, the address parser proceeds to step 54.

In step 54, the address parser determines the appropriate Regional Internet Registry responsible for assignment of the visitor IP address. IP addresses are assigned by one of several Regional Internet Registries (RIRs). IP addresses in the Americas, the Caribbean, and Sub-Saharan Africa are assigned by the American Registry for Internet Numbers (ARIN). Other RIRs include the Asia Pacific Network Information Centre (APNIC), and the RIPE Network Coordination Centre (RIPE NCC). The RIRs maintain databases which may be queried to obtain information on IP address block assignments, and of delegations within IP address blocks. Registration data for an IP address may be obtained by querying an IP address WHOIS server maintained by the corresponding RIR. At step 54, the address parser queries the RIR WHOIS server to obtain the registration record for the visitor IP address. If no organizational entry is available from the RIR WHOIS data, the address parser extracts the domain name from the contact email address for the address block obtained from the RIR WHOIS data, and proceeds to step 56.

In step 56, the address parser determines, on the basis of information extracted during step 54 whether the organizational name or domain name corresponds to that of an Internet service provider (ISP) or proxy server which is likely to merely be providing hosting or connectivity to the organization of the web site visitor. It is desirable to filter out such results, since they will not be truly reflective of the identity of the visitor. If a non-ISP organization or proxy is found, then the address parser proceeds to step 50. If a non-ISP domain name is found (and does not correspond to a domain previously deemed unresolvable), then the address parser proceeds to step 44. Otherwise, the address parser proceeds to step 58. Alternatively, in step 56, if an organizational identity can be directly obtained from the RIR WHOIS data, then the parser may proceed to step 50. In such an embodiment, the address parser may be configured to recognize RIR records indicating sub-delegation of IP addresses to a business entity within a larger ISP-assigned IP address block.

In step 58, the address parser commences an rDNS scan of the IP address block identified in step 54, beginning with addresses adjacent to the visitor IP address, and successively spreading outward to the boundaries of the IP address block. Many companies utilize one or more IP addresses for outbound traffic (such as email or http queries), while utilizing a different IP address for inbound traffic (such as web sites or email gateways). Because companies are generally assigned a set of adjacent IP addresses by their Internet service provider, then it is frequently possible to perform an rDNS query on IP addresses in a region adjacent to the recorded visitor IP address in order to confidently infer the identity of the recorded web site visitor. During the scan in step 58, the address parser may accumulate several hostnames, or may cease scanning upon the detection of the first hostname found nearest to the visitor IP address. The address parser then proceeds to step 60.

In step 60, the hostname(s) obtained in step 58 is tested to determine whether it has been previously deemed unresolvable. If so, then the address parser proceeds to step 62, wherein the hostname is logged as unresolvable, and the address parser returns to step 40 to process the next log entry. The log of unresolvable addresses may be further analyzed manually, in order to associate an organization with the address for future reference by the address parser, or may be permanently flagged as an unresolvable address. Otherwise, the address parser proceeds to step 44 for resolution of the hostname into an organizational identity.

In step 50, the identified organization is compiled into a database which associates that organization with the file requested in the original HTTP-request, so that compiled visitor statistics are provided by the address parser in association with each identified organization. During compilation in step 50, a filter may be applied in order to eliminate entries which through experience have been deemed to be artifacts of the resolution process, and not reflective of actual visitor organizations. For example, where the identified organization is an Internet service provider, or where the IP address fell within a range of dynamic IP addresses assigned to users having dial-up Internet access.

In the method as described thus far, it will be appreciated that any of the techniques of RIR WHOIS lookup or DNS scanning may produce differing results, and that appropriate loop counters and flags may be desirable to prevent divergent results from producing an infinite loop. It will further be appreciated that when a web server entry for a particular IP address has been resolved, then the resolution results may be cached in order to reduce the overhead required to perform resolution for each web server entry.

Compiled results from the address parser is provided to the demographic data retrieval system, which is configured for associating selected demographic data, such as economic data, with the organizations which have been compiled along with web visitation statistics by the address parser. The provision of parsed results to the demographic data retrieval system may be done on a batch, periodic, or real-time basis. The demographic data retrieval system retrieves the organization identities from the compiled organization data produced by the address parser. Then, the demographic data retrieval system queries a demographic information server according to the corresponding organization identity. Such a demographic information server may include, for example, a database such as maintained by Dunn & Bradstreet, which can be queried by organization name to obtain such data as geographic location, postal codes, street addresses, revenue figures, industrial sector codes, industrial identification codes (e.g. SIC codes), etc. The type of external server queried by the demographic data retrieval system can be determined in accordance with predetermined types of demographic or economic data specified by the client as being of interest to that client. Additionally, the client may supply categorization data, such as the identity of the clients vendors, customers, or competitors, so that the demographic data retrieval system can then associate such designations with the database of organizations and web visit statistics produced by the address parser. The economic and/or demographic data pertaining to the identified organizations is compiled into a database 29, which is accessible to the reporting system 25.

The reporting system 25 is configured to generate reports 31 for provision to the client 10. A client may specify predetermined report preferences 27, which are maintained by the system 12 and provided to the reporting system 25. Such preferences may include preferred data elements, reporting formats, and report frequencies desired by the client 10. Alternatively, or in addition thereto, the report preferences may be provided by the client dynamically. In such an embodiment, the reporting system may include an HTTP interface by which a client may specify report preferences desired for a given report, and such preferences are translated into database queries for retrieving the desired data from the database 29 and providing the data to the client in the desired format.

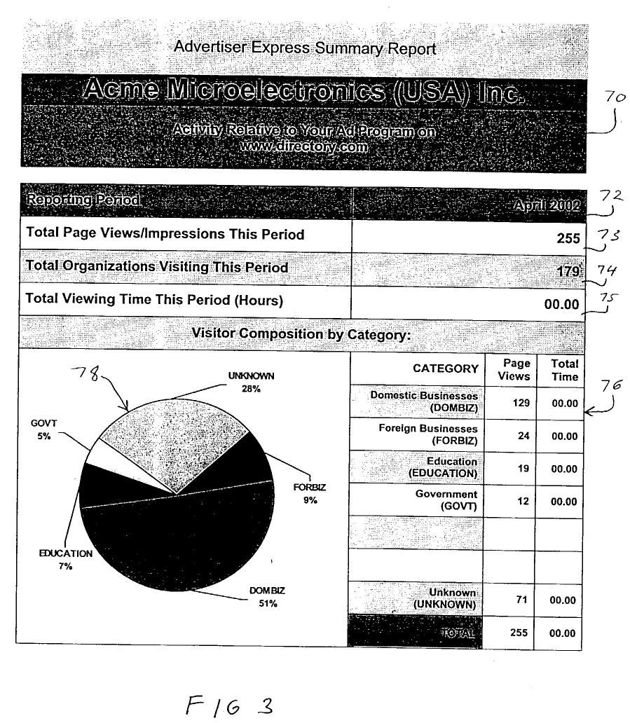

Referring now to FIG. 3, there is shown a page of a sample report prepared by the reporting system 25. The report page shown in FIG. 3 includes a header 70, which identifies the web site to which the report pertains. Following the header 70 is a table showing aggregate web visitor statistics and identifying the report period 72, the total number of page views 73, the total number of distinctly identified visitor organizations 74, and the total time spent viewing the web site 75. Following the aggregate statistics is a graphical and tabular view of visitor statistics to the web site organized by the economic category of the visitor. For example, in the table 76, visitors are arranged into “domestic businesses”, “foreign businesses”, “educational institutions”, and “government agencies”. For each of these categories, the table 76 sets forth the number of page views and viewing time. Adjacent to the table 76 is a pie chart 78 showing the relative percentages of visitors from each economic category.

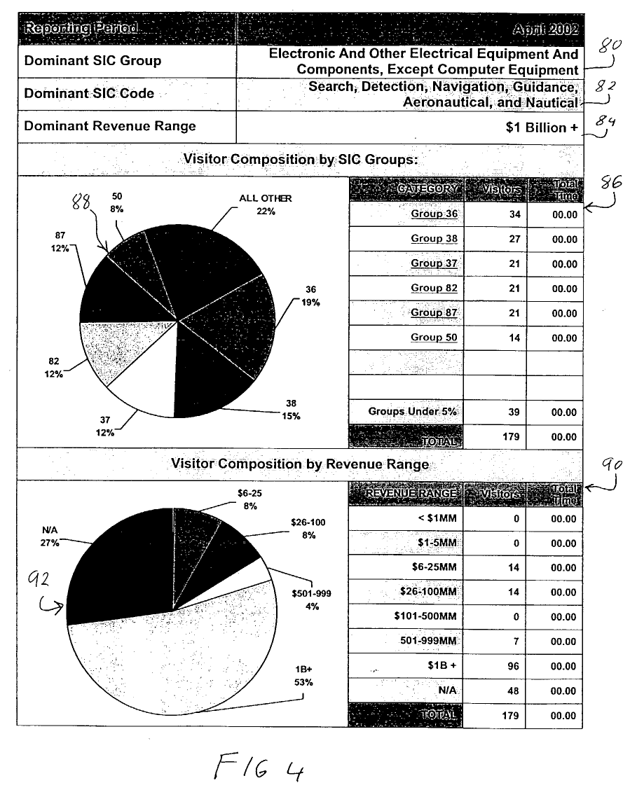

Referring now to FIG. 4, there is shown a subsequent page of a sample report prepared by the reporting system 25. The page shown in FIG. 4, includes a table which shows the “Dominant SIC Group” 80, which identifies the Standard Industry Code Group from which the largest number of web site visitors originated. The following entry is the “Dominant SIC Code” 82, which identifies the Standard Industry Code from which the largest number of web site visitors originated. The final entry in the table is the “Dominant Revenue Range” 84, which identifies the revenue range pertaining to the largest numbe of web site visitors. The following two tables in FIG. 4 show detailed statistics relating to SIC groups and revenue ranges. The table 86 shows the number of web site visitors which originated from organizations identified by each determined SIC code group. Adjacent to the table 86 is a pie chart showing the relative percentages of visitors which originated from organizations identified by each determined SIC code group. The table 90 shows the number of visitors which originated from organizations identified within several ranges of annual revenue, such as less than 1 million dollars per year, up to more than 1 billion dollars per year. Adjacent to the table 90 is a pie chart showing the relative percentages of visitors which originated from organizations earning each identified revenue range.

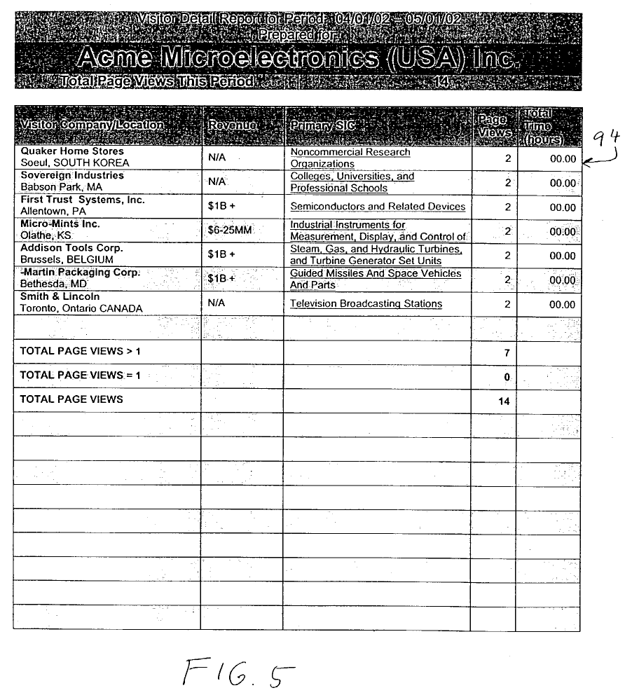

Referring now to FIG. 5, there is shown a subsequent page of a sample report prepared by the reporting system 25. The final page(s) of the report contain a detailed table 94, showing each visitors company and location, the revenue range of each visitor, the primary SIC code of each visitor, the number of page views for each visitor, and the time spent viewing the web site for each visitor.

The terms and expressions used above are intended as terms of description, and not of limitation. It will be appreciated that the invention is amenable to equivalent embodiments within the scope of the claims appended hereto.

We claim:

1. A method of reporting information about visitors to a web site located on a server, comprising the steps of:
obtaining HTTP-request messages from the server;
identifying visitor organizations on the basis of information contained with the HTTP-request messages;
obtaining economic data pertaining to the visitor organizations;
compiling a report of web site visitors organized in accordance with the economic data.

2. The method of claim 1 wherein said economic data includes revenue earned by the organizations.

3. The method of claim 1 wherein said economic data includes standard industrial classifications of the organizations.

4. The method of claim 1, wherein said step of identifying visitor organizations comprises identifying a host name associated with each visitor, and consulting a database associating said host name with an organization.

5. The method of claim 4 wherein said consulting step comprises the step of performing a domain name registration query to identify said organization.

6. The method of claim 4, wherein said step of identifying a host name comprises the steps of,
attempting to obtain rDNS information for each HTTP-request message; and
for each HTTP-request message for which rDNS information is not available, querying a registry of internet protocol address assignments to identify the organization.

7. The method of claim 6, wherein said step of querying a registry of internet protocol addresses comprises the step of querying said registry on the basis of internet protocol addresses adjacent to an internet protocol address contained within said HTTP-request message.

8. The method of claim 5, wherein the step of obtaining economic information comprises consulting a database of economic information including at least one of (a) a revenue figure associated with each organization, and (b) a standard industrial classification associated with each organization.

9. The method of claim 5, comprising the step of producing a report including a tabular compilation of visitor organizations arranged by at least one of (a) a standard industrial classification of each visitor organization, and (b) a revenue range of each visitor organization.

10. A system for compiling and reporting web server visitor statistics, comprising:
an address parser, for obtaining HTTP-request data from the web server and identifying web visitor organizations;
a demographic data retrieval system, for receiving web visitor organization data from the address parser, and connected with a database of economic data, for retrieving economic data pertaining to each identified organization; and
a report generator, for receiving economic data from the economic data retrieval system, and for generating a report of web visitor statistics arranged in accordance with the retrieved economic data.

11. The system of claim 10 wherein the address parser is configured to selective query (a) internet DNS servers, (b) registries of internet protocol addresses, and (b) internet domain name registrar databases, in order to identify an organization associated with each HTTP-request.

12. The system of claim 11, wherein the address parser is configured to query registries of internet protocol addresses on the basis of internet protocol addresses which are adjacent to an address identified in an HTTP-request.

13. The system of claim 10, wherein said economic data includes at least one of (a) a revenue range associated with each visitor, and (b) a standard industrial classification associated with each visitor.
